(19) United States
(12) Patent Application Publication
(10) Pub. No.: US 2011/0049906 A1
(43) Pub. Date: Mar. 3, 2011

(54) APPARATUS FOR CONVERTING KINETIC ENERGY

(76) Inventors: Peter Neville Hughes, London (GB); Annika Marianne Hughes, London (GB); Rebecca Anna Hughes, London (GB); Alexander Peter Hughes, London (GB)

(21) Appl. No.: 12/867,619

(22) PCT Filed: Feb. 16, 2009
(86) PCT No.: PCT/GB09/50145

§ 371 Date: Nov. 12, 2010

(30) Foreign Application Priority Data
Feb. 15, 2008 (GB) 0802832.6

(51) Int. Cl. H02K 7/18

(52) U.S. Cl. 290/1 C

(57) ABSTRACT

Apparatus for converting kinetic energy into usable power (200), comprises a frame (204) arranged to be fixed in a vehicle running track (202) and a plurality of plates (211 to 219 inclusive, and 221 to 229 inclusive) mounted to the frame. Each plate being movable in relation to the frame so as to drive an energy conversion means (232, 234). The energy conversion means has a rotating member (293 in FIG. 19) having variable inertia.

The present invention relates to the conversion of kinetic energy from moving vehicles.

Electric rotating machines for the conversion of kinetic energy to electrical energy, such as electric generators and motors generally have an optimum operating speed, at which the electro-magnetic interaction of a moving component with a stationary produces a desired result. For generators and motors described in this specification, the movement of the moving component is a rotation of an armature about an axis of the motor. For an electric generator the desired result is an output of electrical power derived from an input of mechanical power. For an electric motor the desired result is an output of mechanical power derived from an input of electrical power. In such a rotating machine, conversion of mechanical power to or from electrical power is by means of an interaction between a magnetic field and a plurality of electrical wires. The magnetic field may be derived from an electro-magnet or a permanent magnet, or a combination of both. The plurality of electric wires are normally arranged in a number of coils, each coil being wound around a core of a magnetic material. The core of magnetic material is normally shaped so as to direct the flux of a magnetic field within the rotating machine so that it passes through the coil or coils.

A problem with known electric machines is that on starting the machine, a high torque is required to accelerate the machine to a suitable operating speed. A part of this torque arises from the mechanical inertia of the machine. In part the this torque arises from a load applied to the machine, which in the case of an electric motor is a driven mechanical load, and in the case of an electric generator is an electrical load.

This invention describes as hereinafter set out is by way of example an electrical generator suitable for use with apparatus that is operated on by vehicular traffic passing over it so as to convert a portion of the kinetic energy from each of the passing vehicles into another form of energy. Typically electrical generators operate within a magnetic field which is generally fixed, and either produced as an electro-magnetic field for example by current carrying field coils as a result of relative movement within the generator, or alternatively are constructed with permanent magnets. In both cases, the magnetic field is used to transfer energy from one part of the machine to another, and in the case of a generator thus provides a resistance to rotation which is the consequence of the rotating component moving within the stator, so as to generate an electrical power output and thereby resulting in resistance to rotation.

An intention of this invention is to reduce the mechanical inertia of the electrical machine, and in the particular case of an electrical generator, to also reduce the electrical load on the generator. This is advantageous as it also permits the inertia of the drive mechanism to be reduced.

According to a first aspect of the present invention, there is provided apparatus for converting kinetic energy into usable power, comprising a frame arranged to be fixed in a vehicle running track and a plurality of plates mounted to the frame so that a vehicle running face of each plate is substantially level with the surrounding track, each plate being movable in relation to the track so as to drive an energy conversion means, wherein the energy conversion means comprises a rotating member having variable inertia.

A benefit of the first aspect of the invention is that the energy conversion means is enabled to provide useable power from derived from the kinetic energy of passing vehicular traffic.

Preferably the apparatus further comprises at least a first and a second plate being arranged to be moved sequentially in that order by a vehicle passing over the plates, such movement of each plate arranged to cause rotation of a drive mechanism, wherein at least the second plate is arranged to impart a greater degree of rotation to the drive mechanism than the first plate.

According to a further aspect of the present invention, there is provided apparatus for converting kinetic energy into usable power, comprising a frame arranged to be fixed in a vehicle running track and a plurality of plates mounted to the frame so that a vehicle running face of each plate is substantially level with the surrounding track, each plate being movable in relation to the track, at least a first and a second plate being arranged to be moved sequentially in that order by a vehicle passing over the plates, such movement of each plate arranged to cause rotation of a drive mechanism, wherein at least the second plate is arranged to impart a greater degree of rotation to the drive mechanism than the first plate. A benefit of the further aspect of the invention is that a vertical force exerted by the first plate upwardly on a passing vehicle may be similar to a vertical force exerted upwardly by the second plate.

Preferably the apparatus comprises energy conversion means comprising an electrical generator.

A benefit of the energy conversion means comprising an electrical generator is that the power output from the apparatus may be easily utilised.

Preferably the energy conversion means further comprises means for storing electrical energy.

A benefit of electrical energy storage is that an electrical power output may be maintained during periods when there is no vehicular traffic passing over the apparatus.

Preferably the electrical generator comprises a rotating part having variable inertia.

A benefit of the generator having a rotating part with a variable inertia, is that a maximum stress on the drive when starting the rotation of the rotating part is reduced.

Preferably each plate is arranged to protrude the surrounding surface in a first position when it is not acted on by a vehicle. Preferably at least an edge of the vehicle running face is substantially at the same level as the surrounding surface. In an embodiment, the edge may comprise a surface with a radiused and/or curved and/or bevelled surface.

A benefit of the edge being substantially at the same level is that vehicle tyres are not damaged as they contact the plate.

Preferably each plate is arranged to move to a second position when it is acted on by a vehicle. Preferably when in the second position a highest portion of the vehicle running face is at least substantially level with the surrounding surface at least the portion where a vehicle is acting on the plate.

In an embodiment, when in the second position a highest portion of the vehicle running face is below a level of the surrounding surface at least a portion of the plate.

A benefit of the plate being permitted to move so that a portion of the plate is below the surrounding surface is that where a heavy vehicle with large wheels passes over the plate a maximum movement of the plate in the vertical direction can occur.

Preferably at least a portion of each of the plates moves in a downwardly substantially vertical direction as a vehicle passes over the plate. A benefit of the plate moving in a vertical direction is that the weight of a passing vehicle may act efficiently on the drive mechanism.

Preferably each of the plates is resiliently urged from the second position to the first position.

Preferably each of the plates is restrained from moving higher than the first position.

Preferably the downwardly substantially vertical direction is an arcuate movement about an axis.

Preferably each of the plates is pivotally supported at or adjacent to one end so as to resist vertical movement as a vehicle passes over the plate. More preferably the plate is also arranged to resist horizontal movement.

A benefit of the plates being pivotally supported at an end is that construction of the mechanism may be simplified. A benefit of the plate being able to resist horizontal movement is that a vehicle may traverse the plates in a controlled manner.

Preferably the apparatus further comprises two similar sets of plates, one on either side of a longitudinal centre line along the vehicle running track.

In an embodiment the end pivotally supported is adjacent the centre line along the vehicle running track. Preferably each plate is arranged to move about a common axial centre line, the axial centre line parallel to the longitudinal centre line of the vehicle running track.

In another embodiment the end pivotally supported is adjacent a side edge along the vehicle running track. Preferably each plate is arranged to move about a common axial centre line, the axial centre line parallel to the longitudinal centre line of the vehicle running track.

Preferably a transverse fixed portion of track is provided between each plate along a line of the vehicle running track. A benefit of the transverse fixed portions is that a disturbance to the vehicle as it traverses the plates is minimised.

Preferably a longitudinal fixed portion of track is provided between each set of plates along the longitudinal centre line. A benefit of the longitudinal fixed portion is that two wheeled vehicles may be provided with a safe fixed running path.

Preferably the plates of each of the two similar sets of plates are disposed symmetrically about the longitudinal centre line.

Preferably the common axial centre line of each set of plates is displaced symmetrically about the longitudinal centre line. In an alternative embodiment, the common axial centre line of each set of plates is preferably common between each set of plates, and is co-incident with the longitudinal centre line.

Preferably the energy conversion means further comprises a drive mechanism, the drive mechanism arranged to transmit kinetic energy to the electrical generator.

Preferably the drive mechanism comprises a geared mechanism to translate the substantially vertical movement of the plates to a rotary movement to operate the generator.

Preferably the geared mechanism comprises at least a rack and pinion arrangement, a rack being mounted to each of the plates at a distance from the pivotally supported end, each of the rack and pinion arrangements being arranged to translate the substantially vertical movement of the plates to a rotary movement to operate the generator. Preferably a diameter of a pinion of a first plate is a larger diameter than a pinion of a second plate.

A benefit of the first pinion being larger than the second pinion is that the first pinion will impart more torque to the drive mechanism for the same downward force than the second pinion.

In a further embodiment, preferably the drive mechanism comprises a connecting rod and crank-shaft mechanism to translate the substantially vertical movement of the plates to a rotary movement to operate the generator. Preferably the connecting rod and crank-shaft mechanism comprises a connecting rods mounted to each of the plates at a distance from the pivotally supported end.

Preferably a length of a crank of a first plate is longer than a length of a crank of a second plate.

A benefit of the first crank being longer than the second crank is that the first crank will impart more torque to the drive mechanism for the same downward force than the second pinion.

Preferably the plates and drive mechanism further comprises at least a clutch, the clutch or clutches being arranged so that as a particular plate is moved in the substantially vertical direction and energy is imparted to the drive mechanism, the other plates in the same set of plates may remain in the first position.

Preferably each of the pinions and or cranks comprises a said clutch.

According to the present invention, there is provided an electrical rotating machine, comprising a rotatable armature and a fixed stator, the armature arranged to rotate about an axis, wherein the armature comprises a plurality of sets of each of a plurality of movable portions, each movable portion movable from at least a first position when the armature is stationary to a second position when the armature is rotating, wherein a dimension of a radial gap between each movable portion and the stator decreases when the moveable portion moves from the first position to the second position, the armature and the stator are arranged such that a magnetic flux coupling the armature and the stator crosses the gap when the movable portions are in the second position, and wherein at least a first set is arranged to move to the second position at a first speed of rotation, and at least a second set is arranged to move to the second position at a second speed of rotation, the second speed being higher than the first speed.

A benefit of the invention is that by arranging the electrical machine so that it has a larger gap between the armature and the stator when it is starting from rest, than when it has reached an operating speed, is that the electro-magnetic characteristics and or the mechanical characteristics of the electrical machine may be arranged to be different when starting to when operating such that starting is facilitated.

Preferably the rotating machine is an electrical generator.

Preferably the electrical generator is arranged to convert kinetic energy from passing vehicles into electrical power.

In an alternative embodiment, preferably the electrical machine is an electric motor.

Preferably the moveable portions each comprise at least in part a magnetic portion. A benefit of the invention is that when the moveable portions are in the first position, any resistance to rotation of the armature due to magnetic losses, for example arising from eddy currents in the armature or stator, are minimised.

Preferably the magnetic portion comprises a permanent magnets.

Preferably the magnetic portion comprises an electro-magnet.

Preferably the magnetic portion comprises a permanent magnet and an electro-magnet. A benefit of the magnetic portion comprising both a permanent magnet and an electro-magnet is that a strength of the magnetic field may be controlled. A further benefit is that a high strength magnetic field may be obtained by combining both a permanent magnet and an electro-magnet.

Preferably the moveable portions are arranged to move radially.

Preferably in another embodiment the moveable portions move arcuately.

Preferably the armature arranged to rotate within the stator.

Preferably the moveable portions are urged towards the axis of rotation

Preferably the moveable portions are resiliently urged towards the axis of rotation.

Preferably a moment of inertia of the armature when the moveable portions are in the first position is less than the moment of inertia when the moveable portions are in the second position.

Preferably this invention provides a means of lowering both the inertia and resistance to rotation by means of providing one or more coil windings or magnetic portions incorporated within suitably designed moveable weights or moveable portions so arranged as to be drawn in and/or allowed to move by springs or other suitable mechanism preferably connected to a central shaft or hub, whereby when the mechanism is stationary or rotated at a low speed, the weights will be in close proximity to the centre of rotation thereby minimising the inertia but also will not be in sufficiently close proximity to the stator as to be impeded by any magnetic field and the armature will therefore be capable of reaching a higher rotational speed than would otherwise be possible for a given power input.

Preferably the magnetic flux coupling between the armature and the stator when the moveable portions are in the first position is less than half the magnetic flux coupling when the moveable portions are in the second position.

Preferably in another embodiment the magnetic flux coupling between the stator and the armature when the moveable portions are in the first position will be less than one quarter that when the moveable portions are in the second position.

Preferably when a sufficient rotational speed is reached, the resulting centrifugal force will act upon the weights or moveable portions containing the electrical coil windings or magnetic portions and when sufficient angular velocity is achieved, the weights are designed to come into close proximity to the stator. The magnetic coupling with the stator thereby resulting in the excitation of the magnetic field, creating the generation of an electric current output. An embodiment of this invention is designed to be particularly suitable for utilisation in any situation when the force causing it to rotate is intermittent or when a given rotational speed is required before the magnetic field is activated.

Preferably such a sufficient rotational speed or angular velocity of the armature is more than forty percent of an intended optimum operating speed. More preferably the sufficient rotational speed or angular velocity of the armature is less than ninety percent of the intended optimum operating speed.

Preferably at least two of the moveable portions are arranged to move in such a way that an out of balance moment arising from the rotation of the one moveable portion is counterbalanced by the out of balance moment arising from the other moveable portion or other moveable portions, as the moveable portions move from the first position to the second position. A benefit of the moveable portions being arranged to counter-balance each other is that as the speed of rotation of the armature increases from rest to a designed operation speed there are substantially no out-of balance forces transmitted to the bearings supporting the armature.

Preferably the moveable portions have an outwardly facing surface, facing away from the axis of rotation, the outwardly facing surface of each moveable portion having a radius of curvature, substantially that of the radius of the surface from the axis when the moveable portion is in the second position. A benefit of a the radiused surface is that the moveable portion may rotate in close proximity to an inside surface of the stator when the electrical machine is operating at the designed speed.

The said weights or moveable portions described herein, in one convenient embodiment may be designed to have a hole through the centre or in any convenient position to have a round or suitably shaped bar or tube to be inserted through the hole to facilitate the movement of the weights towards or away from the shaft or hub referred to, or in any alternative convenient direction. The weights referred to may be of any suitable shape, size or material. The bar or bars in turn may be so arranged as to, in one further convenient embodiment be attached to a central boss or shaft and any suitable number of bars, shafts or bosses may be fixed and arranged to radiate out from the hub(s) or shaft(s) resulting in a form similar to that of spokes in a wheel or any other suitable shape(s).

At the outside edge of these bars or shafts, abutments may be provided or a circular ring manufactured from any suitable material, such as a circlip may be fitted to an end of the bar remote from the axis of rotation so as to contain the weights or moveable portions.

In an alternative embodiment, the weights or moveable portions may simply rotate within a tube(s) containing the stator(s) or other suitable electrical wiring arrangement to enable the electrical machine to act as a generator, motor or other rotating mechanism resulting in an effective means of maximising energy utilization as described herein.

Specific embodiments of the invention will now be described by way of example with reference to the accompanying drawings in which:—

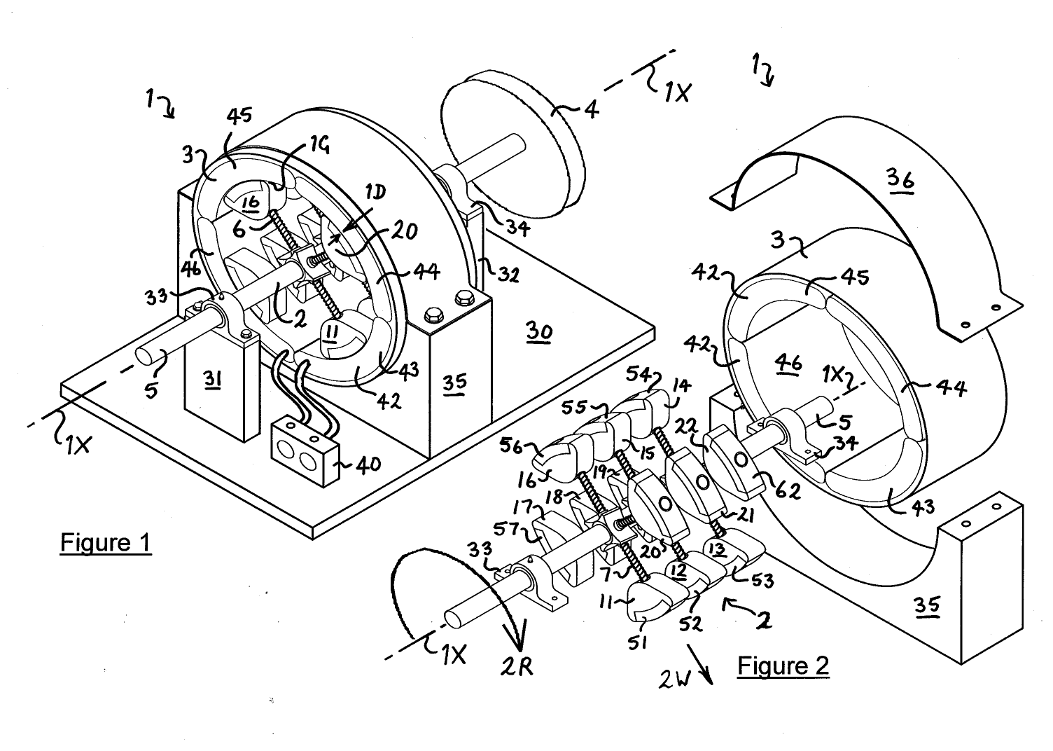

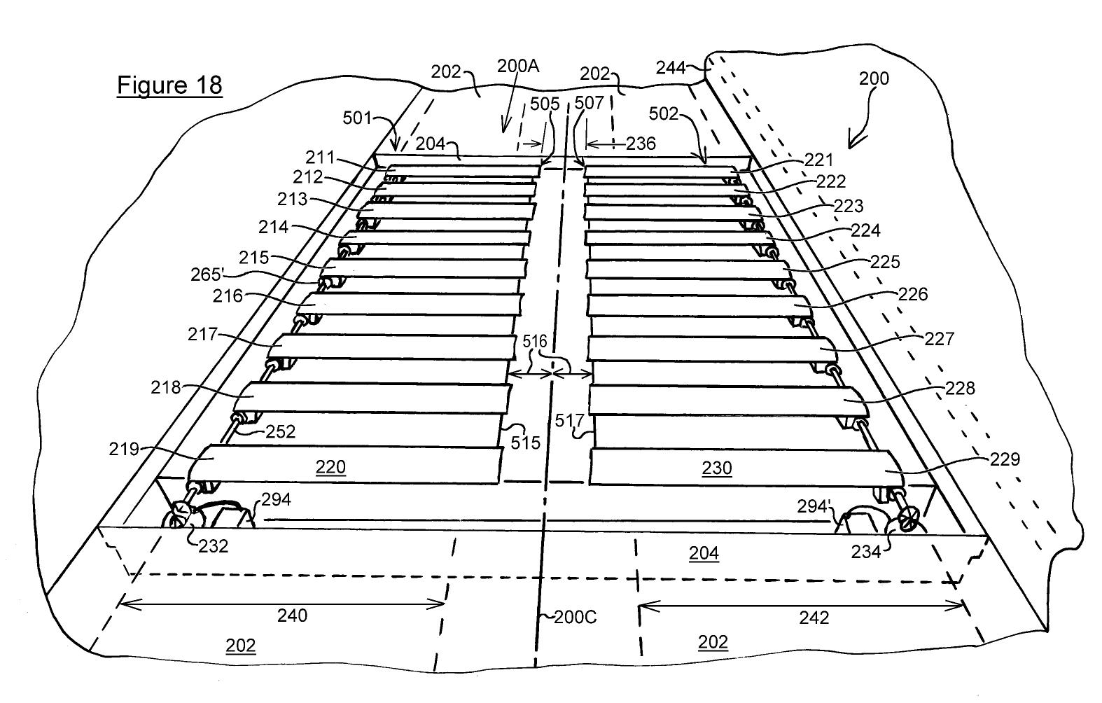

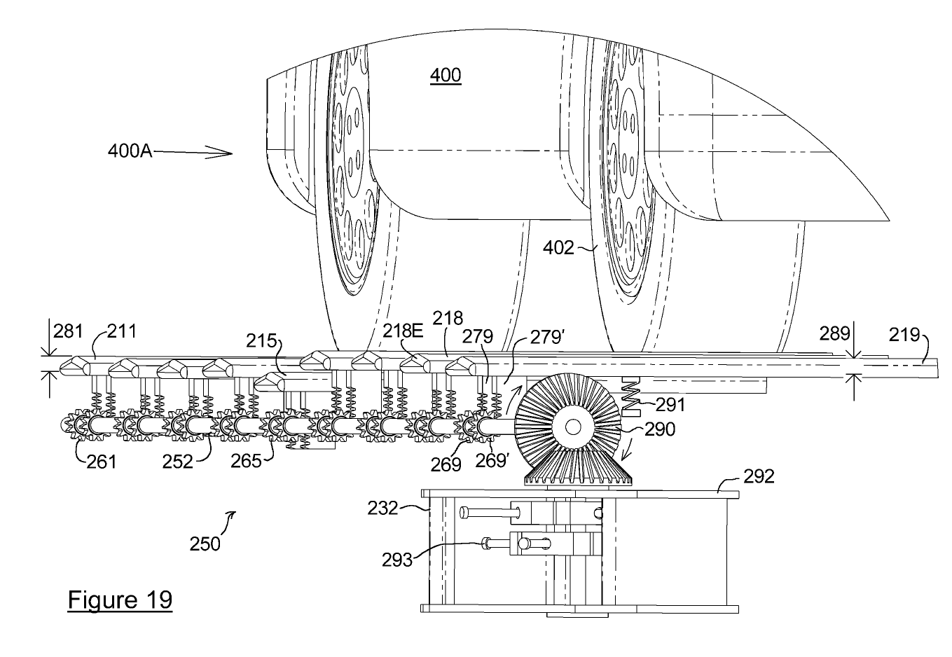

FIG. 1 is a perspective view of a first embodiment of an electrical machine according to the invention that is suitable for use with the apparatus shown in FIG. 18;

FIG. 2 is an exploded view of the first embodiment shown in FIG. 1;

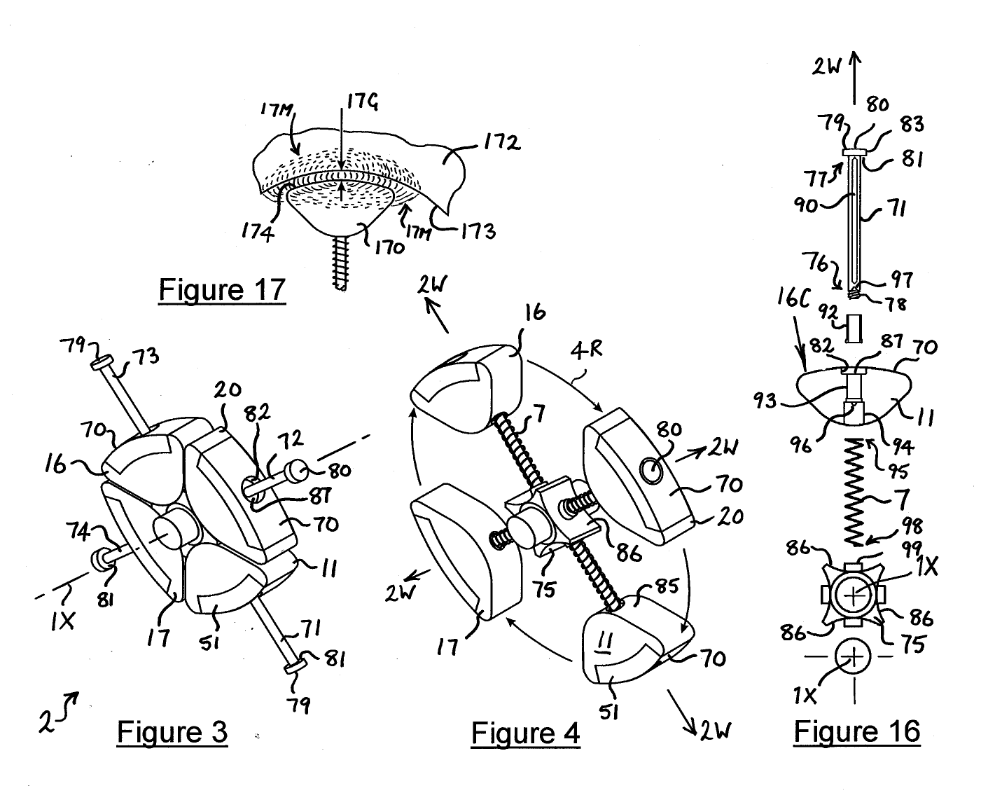

FIG. 3 is a scrap perspective view of the first embodiment shown in FIG. 1 showing a portion of the armature with moveable portions in a first position;

FIG. 4 is a scrap perspective view of the first embodiment shown in FIG. 1 showing a portion of the armature with moveable portions in a second position;

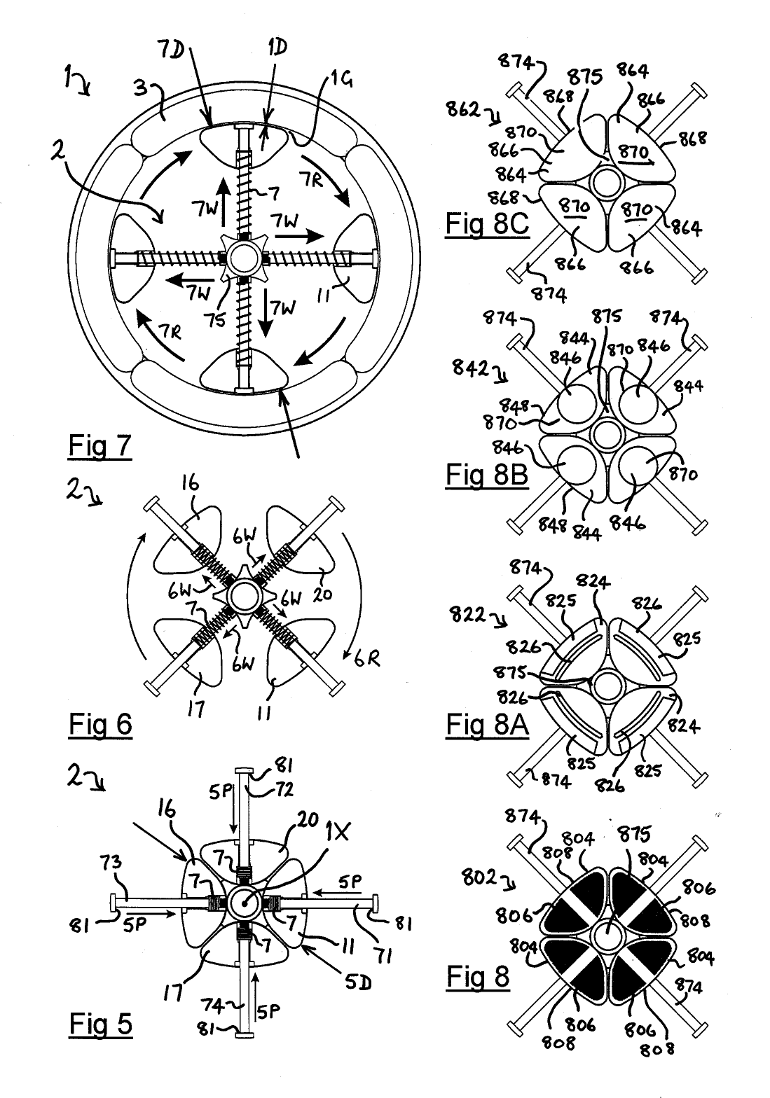

FIG. 5 is a partly sectioned end view along an axis of rotation of the armature of the first embodiment, with moveable portions in a first position;

FIG. 6 is a partly sectioned end view along an axis of rotation of the armature of the first embodiment, with moveable portions in an intermediate position;

FIG. 7 is a partly sectioned end view along an axis of rotation of the armature and stator of the first embodiment, with moveable portions in the second position;

FIGS. 8, 8A, 8B and 8C are end views along an axis of rotation of alternative embodiments of armatures according to the invention.

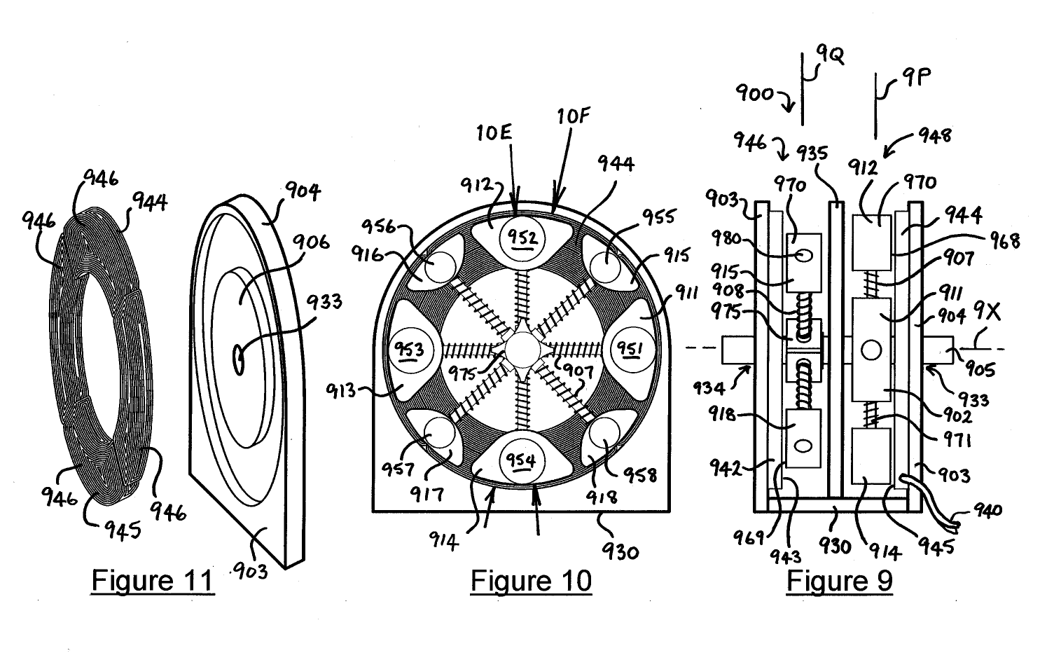

FIG. 9 is a side view of a second embodiment according to the invention;

FIG. 10 is an end view of the second embodiment shown in FIG. 9.

FIG. 11 is a perspective view of a stator winding and a stator support plate;

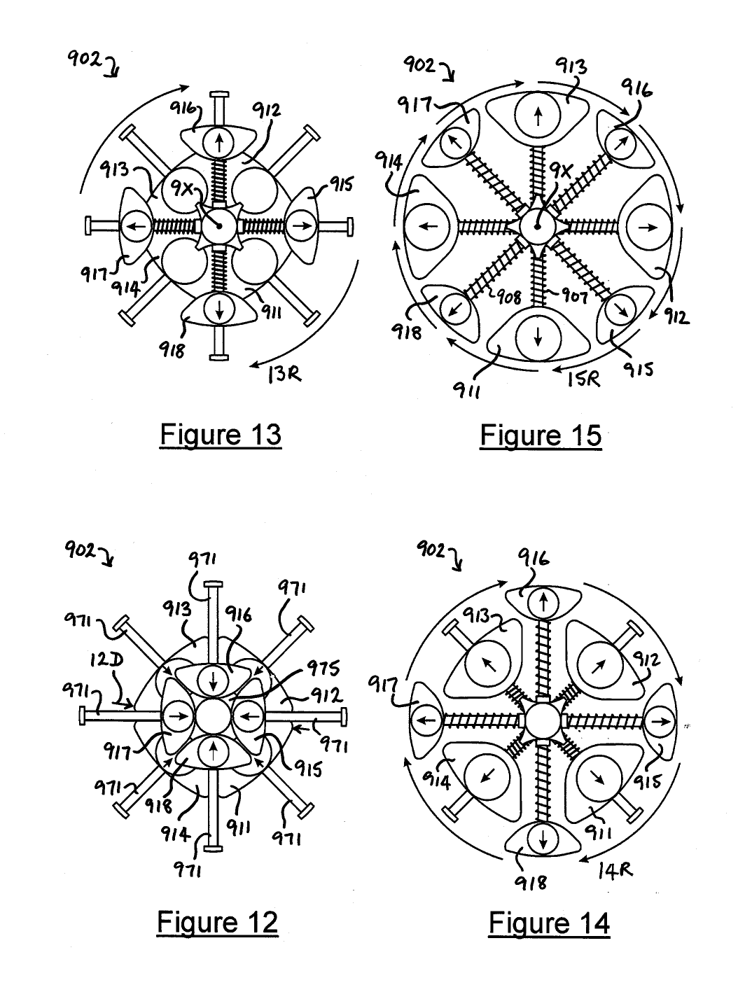

FIG. 12 is an end view of the armature for the second embodiment, when the moveable portions are in a first position;

FIG. 13 is an end view of the armature for the second embodiment, when a first set of moveable portions are in an intermediate position and a second set of moveable portions are still in the first position;

FIG. 14 is an end view of the armature for the second embodiment, when the first set of moveable portions are in a second position and the second set of moveable portions are in an intermediate position;

FIG. 15 is an end view of the armature for the second embodiment, when the moveable portions are in a second position;

FIG. 16 is an exploded view of a section through a moveable portion together with a support bar, a hub and the ancillary parts forming a part of the armature of either the first or the second embodiments described herein;

FIG. 17 is an enlarged scrap view of a stator and a moveable portion according to either the first or second embodiments of the invention;

FIG. 18 is a perspective view from above of an embodiment of the present invention, showing apparatus for converting kinetic energy into usable power fixed in a vehicle running track, but with a cover removed to show hidden features;

FIG. 19 is a perspective view from below of the apparatus shown in FIG. 18, with a motor vehicle traversing the apparatus shown in FIG. 18;

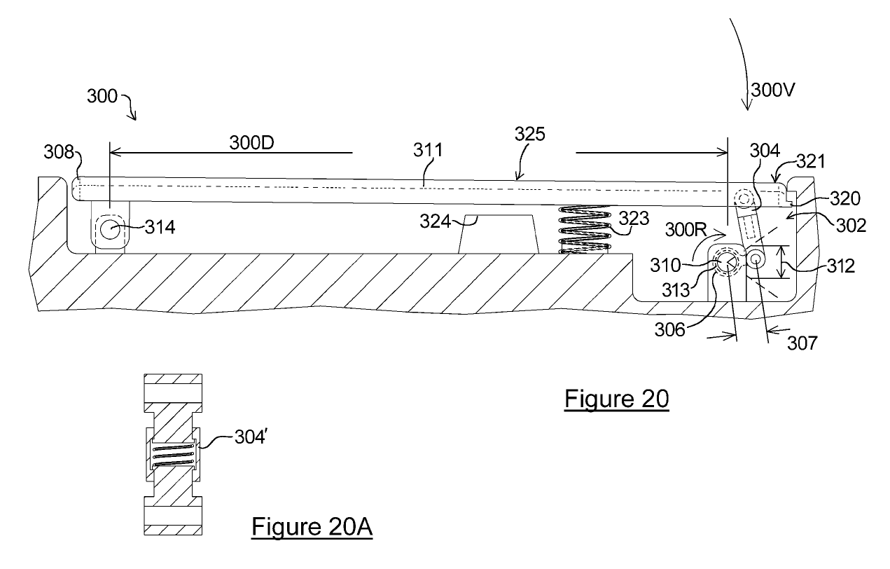

FIG. 20 is a view along a longitudinal direction of an alternative drive mechanism;

FIG. 20A is a sectioned view of an alternative connecting rod for use in the mechanism shown in FIG. 20;

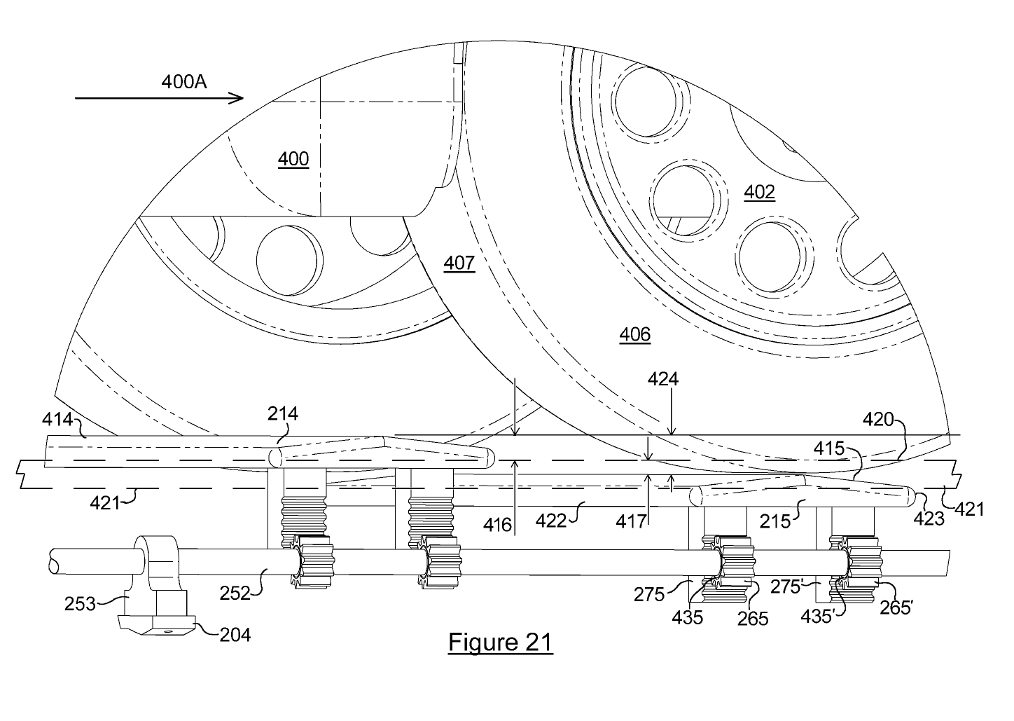

FIG. 21 is a view of a vehicle wheel acting on one plate of the apparatus shown in FIG. 18;

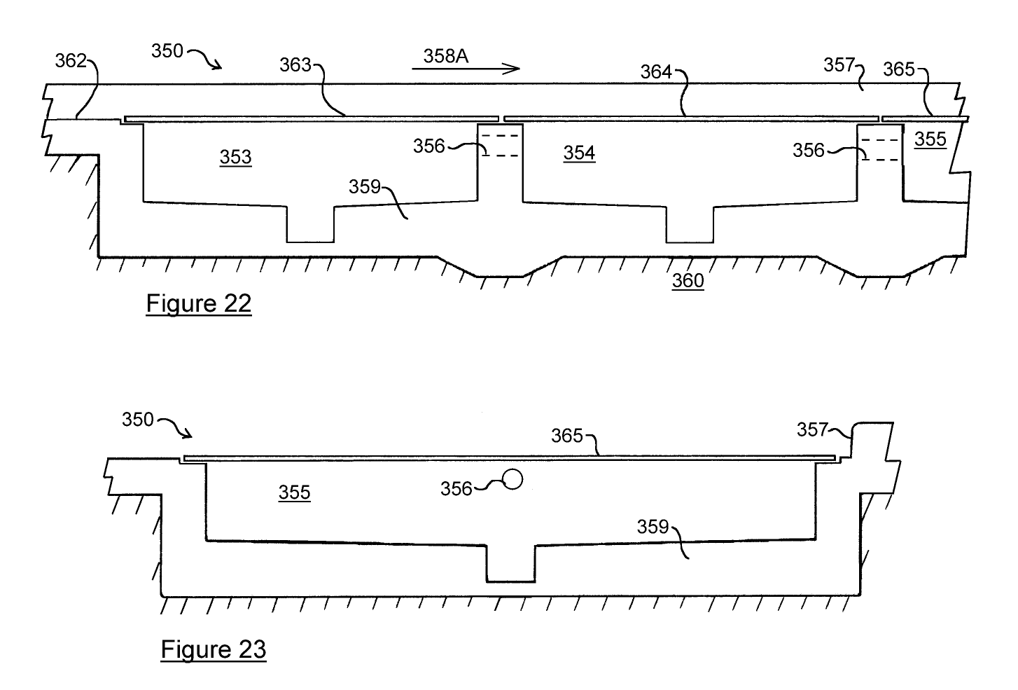

FIG. 22 is a longitudinal cross section of an alternative embodiment of a frame suitable for apparatus similar to that shown in FIG. 18; and

FIG. 23 is a transverse cross section of the alternative frame shown in FIG. 22.

From FIG. 1 an electrical rotating machine 1 according to the invention is shown, having a rotatable armature 2 and a fixed stator 3. The armature 2 is arranged to rotate in the direction of arrow 2R (shown in FIG. 2) about an axis 1X. The armature 2 has a plurality of movable portions 11 to 22 inclusive, which in FIGS. 1 and 2 and 4 are shown in a second position, and in FIG. 3 are shown in a first position. Each movable portion is movable from the first position when the armature is stationary to the second position when the armature is rotating as shown in FIGS. 1 and 2, when a dimension 1D of a radial gap 1G between each movable portion and the stator is small. From the description of FIGS. 5, 6 and 7 below, it can be seen that the gap decreases when the moveable portion moves from the first position to the second position. The armature and the stator are arranged as shown in FIG. 17 such that a magnetic flux coupling the armature and the stator crosses the gap when the movable portions are in the second position.

From FIG. 1, it can be seen that the electrical machine 1 also comprises a mounting plate 30, to which bearing supports 31 and 32 are mounted. The bearing supports support bearings 33 and 34, in which the armature 2 is free to rotate within the stator 2, which is also mounted by means of support block 35 and clamp 36 to the mounting plate 30.

Terminal block 40 is electrically connected to stator windings 42. The stator windings 42 comprise a plurality of coils 43, 44, 45, 46, the coils interconnected so as to optimise the electrical performance of the machine, and the coils being terminated at the terminal block.

While only four stator coils are shown in these figures, it will be appreciated that the number of coils may be varied in a particular embodiment according to the particular application intended for that embodiment. For example, in a three phase generator it would be convenient for the number of coils to be a multiple of three, and in this case at least three terminals would need to be provided to allow for connection to the stator windings. In another example, where a generator was to be used for a single phase alternating current output, it would be convenient for the number of coils to be a multiple of two.

Likewise in the particular case, where the electrical machine is an electric motor for connection to a three phase supply, it would again be convenient for the number of coils to be a multiple of three, and in this case at least three terminals would need to be provided to allow for connection to the stator windings.

Each of the moveable portions 11 to 22 comprise a magnet 51 to 62 inclusive respectively (note for clarity not all are labelled in FIG. 2). Each of the moveable portions is mounted slidably on a bar 6 (only one labelled) and is resiliently urged towards the axis of rotation 1X by a resilient member 7. As a result of the rotation of the armature at or above a particular speed, as shown in FIGS. 1 and 2, the moveable portions have each moved outwardly away from the axis 1X, as shown for example by moveable portion 11 which has moved in the direction of arrow 2W against the tensile force exerted on it by the resilient member 7.

In the case of these figures, the resilient member 7 is shown as a wire tension spring, but in alternative embodiments could be a leaf spring, or a pressurised gas spring, of some other resilient arrangement.

A pulley or gear wheel 4 is mounted to shaft 5 of the armature 2.

In the case of an electric generator the pulley or gear wheel 4 is used to provide an input of mechanical power, and in the case of an electric motor, the pulley or gear wheel 4 is used to provide an output of mechanical power from the electrical machine.

In FIGS. 1 and 2, the stator windings 42 are shown to comprise a plurality of coils 43, 44, 45, 46 each of which extend axially substantially the whole length of the stator. However, where the movable portions as shown in FIGS. 1 and 2 are arranged in sets, that is portions 11, 17, 16 and 20 are arranged in a first set, and moveable portions 12, 18, 16 and 21 are arranged as a second set, and moveable portions 13, 19, 14, 22 are arranged as a third set, the stator winding preferably comprises three sets of coils along the length of the stator. Hence each set of coils is arranged to primarily interact with one of the sets of moveable portions.

From FIG. 3, which is a scrap perspective view of the first embodiment 1 shown in FIG. 1, a portion of the armature 2 is shown with moveable portions 11, 20, 16 and 17 in a first position. The moveable portions would be in this first position when the armature is not rotating, or when it is rotating a low speed such that a centrifugal force acting on each of the moveable portions urging them away from the axis 1X, is less than the tensile force exerted by resilient member 7. Each moveable portion has a curved outer face 70, having a radius of curvature 16C (shown in FIG. 16) substantially the same as the radius of the face 70 from the axis 1X when the moveable portions are in the second position. The moveable portions 11, 20, 16 and 17 are each slidably mounted to a bar 71, 72, 73 and 74 respectively, each bar securely mounted to a hub 75 at an inner end 76 by means of a threaded portion 78. At an outer end 77, each bar is provided with a head 79 having a radiused outer face 80, having substantially the same radius 16C as face 70. Each head 79 has a diameter 83 and an abutting face 81, arranged to abut a stop surface 87 (only one labelled) of each of the moveable portions. Each moveable portion also has a recess 82 to receive head 79.

From FIG. 4, which shows the same portion of the armature 2 as shown in FIG. 3, but with moveable portions 11, 20, 16 and 17 shown in a second position due to rotation of the armature 2 in the direction of arrows 4R, shaped receiving portions 86, which abut an inward face 85 of the respective moveable portion when the moveable portions are in the first position. In the first position the moveable portions have a minimum overall diameter 5D (see FIG. 5). When the armature is rotating, the abutting face 81 abuts the stop surface 87 to prevent further movement of the moveable portion in the radial direction of arrow 2W. In the second position, the face 80 is preferably substantially flush or below face 70.

FIG. 16 shows an exploded view of a section through a part of the armature 2 having the moveable portion 11 as a typical example of the arrangement of the first and second embodiments. The bar 71 has a means to prevent rotation of the moveable portion about the bar, which in this embodiment is a longitudinal protrusion 90 (only shown in FIG. 16) which extends along the length of the bar. The protrusion 90 co operates with a detent (not shown) in a bearing 92 arranged to fit within bore 93 of the moveable portion 11. The moveable portion 11 has a large bore 94 to receive an end 95 of the resilient member 7. The large bore 94 has a location 96 to securely retain the end 95 to the moveable portion. The bar 71 has a location 97 to retain an end 98 of the resilient member. Hence when assembled, the resilient member may urge the moveable portion 11 towards the hub 75 so that face 85 abuts receiving portion 86. The hub 75 is provided with threaded holes 99 to receive the threaded end 76 of the bar 71.

Hub 75 may itself be magnetic, so as to exert an attractive force on the moveable portions. Such a hub arrangement would prevent the movement of the moveable portions until such time as the speed of rotation had increased sufficiently. Such a non linear relationship between rotational speed of the armature and the displacement of the moveable portions would be advantageous in certain applications where starting torque was particularly low.

In a further embodiment of the invention similar in all respects to the present embodiment, other than the movement of the moveable portions is controlled, so as to prevent the moveable portions from moving up or down the bars should the speed of the armature fluctuate slightly. Such fluctuation could occur, say, in the case of a generator by a pulsing of an input of power to the pulley 4. The movement may be controlled by arranging bearing 92 so that it lightly grips the bar, giving rise to mechanical frictional. Alternatively, the control of the movement may be obtained by the use of a viscous coating or lubrication between the bearing and the bar. In a further alternative arrangement, the control may be provided by an additional damping mechanism, such as a dash pot positioned between the moveable portion and the rest of the armature.

In a further alternative embodiment, control of the movement of the moveable portions may be effected by a hydraulic mechanism.

In a yet further alternative embodiment, control of the movement of the moveable portions may be effected by a spiral thread such as a screw thread on a rotatable part. The rotatable part may have an axis co-axial with the respective bar, or it may have an axis co-axial with the axis of the armature.

It will be appreciated that alternative mechanical arrangements to that shown in FIG. 16 would provide the same constraints and degree of freedom of the moveable portions to move from the first position to the second position.

While the resilient member 7 has been described with reference to the first embodiment as a tension spring, a similar effect would be obtained if the resilient member were a compression spring mounted between the abutting face 81 and the stop surface 87.

In an alternative embodiment not shown herein, the resilient member may be a pneumatic or gas spring.

FIG. 17 is an enlarged scrap view of a typical moveable portion 170 and stator 172 according to the invention and similar to those described with reference to the first and second embodiments, when the moveable portion is substantially in the second position. A gap 17G between an inner radiused surface 173 of the stator and an outer radiused face 174 of the moveable portion is small and is bridged by the magnetic flux 17M (shown by dotted lines in FIG. 17) that couples the armature and the stator.

When the moveable portions are in the first position, they are sufficiently remote from the stator that a magnetic coupling between the armature and stator is significantly reduced.

From FIG. 5 a partly sectioned end view along an axis of rotation 1X of the armature 2 of the first embodiment 1, with moveable portions in a first position, where they are held close to the axis of rotation. The moveable portions 11, 20, 16 and 17 are urged inwards in the direction of arrows 5P by the resilient members 7. Hence the armature has a minimum moment of inertia, and it is easy to start the armature to rotate about axis 1X.

Known generators have an inherently high inertia which is substantially reduced by having the movable portions shown in this invention. Hence a starting torque for a generator according to this invention is substantially lower than for known generators of a comparable output.

Known generators also inherently have a resistance to rotation as a result of the magnetic field present. In this invention, the resistance to rotation when starting arising from the magnetic field is reduced because the armature pole pieces are at a substantially reduced diameter, thereby reducing the magnetic coupling with the stator, and hence the resistance to rotation. This reduced resistance to rotation is maintained as the generator starts to rotate until the speed of rotation has increased such that the centrifugal force on the magnets has caused them to move outwards to a position where the generator reaches excitation.

The minimum overall diameter 5D when the moveable portions are in the first position, is less than the maximum overall diameter 7D (see FIG. 7) when the moveable portions are in the second position.

FIG. 6 is the same partly sectioned end view as shown in FIG. 5, but with the moveable portions in an intermediate position between the first position and the second position. As the speed 6R of the armature increases the moveable portions move from the first position shown in FIG. 5 through the intermediate position shown in this FIG. 6 to the second position shown in FIG. 7. While in this position there is substantially an equilibrium between the centrifugal forces causing the moveable portions 11, 20, 16 and 17 to move outwards in the direction of arrows 6W (which are in the same direction as arrows 2W) and the tensile force exerted by the resilient members 7.

Any imbalance in the forces will have an effect of causing the moveable portions to move inwards or outwards so as to tend to a position where the forces are balanced. When the forces are balanced, there is no net force acting on the moveable portions so as to cause them to move.

FIG. 7 shows the same partly sectioned end view along an axis of rotation 1X of the armature 2 as shown in FIGS. 5 and 6 but with the moveable portions 11, 20, 16 and 17 in the second position, this figure also includes the stator 3. The speed of rotation 7R of the armature in this figure is greater than the speed of rotation 6R of the armature in FIG. 6. Since the speed of rotation 7R has reached or exceeds a desired minimum operating speed, the moveable portions have fully moved in the direction of arrows 7W to the second position.

FIGS. 8, 8A, 8B and 8C are end views along an axis of rotation of alternative embodiments of armatures according to the invention, where most features are identical with those already described with reference to the first embodiment. In these figures, armature 802, 822, 842 and 862 each comprise a hub 875 and four identical bars 874 extending from the hub, at regular angular spacings so as to form a substantially rigid assembly. In operation, each of the embodiments is arranged so that the armatures are each mounted rotatably to a stator, and the moveable portions moves from a first position as shown through intermediate positions to a second position as a speed of the armature increases. The electrical machine may in each case be arranged to operate as an electrical generator or as an electrical motor.

A desired operational characteristic of the electrical machine may be obtained by careful selection of magnetic materials and the other materials used for the moveable portions, so as to obtain a desired combination of weight and magnetic properties.

The armature 802 has four identical moveable portions 804, each having an electrical winding 806 arranged to be connected when the armature is mounted within a stator by means of a commutator or slip rings (not shown) to a source of electrical energy. The windings 806 are arranged so that when the windings are energised they each create a magnetic field about a curved pole face 808 of their respective moveable portion. In an embodiment using an armature with the moveable portions 804, the armature could comprise permanent magnets.

The armature 822 has four identical moveable portions 824, each having a permanent magnet 825 and an electrical winding 826 arranged to be connected when the armature is mounted within a stator by means of a commutator or slip rings (not shown) to a source of electrical energy. The windings 826 are arranged so that when the windings are energised they each create a magnetic field about a curved pole face 828 of their respective moveable portion. The permanent magnets are arranged to provide a magnetic field about the curved pole face 829. The electro-magnetic field is preferably arranged to be additive to the field from the permanent magnets.

The armature 842 has four identical moveable portions 844, each having an cylindrical permanent magnet 846 mounted within the moveable portion. The magnets 846 are arranged to provide a magnetic field about each side 870 (only one side visible) of their respective moveable portion, rather than the curved faces 848. This embodiment is particularly suited to an arrangement such as that shown in the second embodiment described with reference to FIG. 9, where the stator is positioned alongside a disc like armature.

The armature 862 has four identical moveable portions 864, each comprising a magnet 866. Each moveable portion is magnetised so that a magnetic field preferably extends principally from or about the desired pole face, either the sides 870 where the stator is arranged axially alongside the armature, or the curved pole face 868 where the stator is arranged radially about the armature.

While in the embodiments described with respect to the drawings, the moveable portions are constrained to move in a radial direction with respect to the axis of rotation of the armature, alternative arrangements where the moveable portions are constrained to move away from the axis in a direction other than radially as the speed of rotation of the armature increased would provide the same benefits as the embodiments described. For example, the moveable portions could move in a tangential direction along a slide similar to the bar described above. In a further example, the moveable portions could be pivotably mounted to the armature, arranged so that they move in an arcuate manner from a first position close to the axis of rotation to a second position away from the axis of rotation, the second position being closer to the stator than the first position. In this example, an axis about which the moveable portions pivot could be parallel to the axis of rotation or perpendicular to the axis of rotation or at an intermediate angle between these.

FIG. 9 shows a side view of a second embodiment 900 according to the invention, which has a stator 903 and an armature 902. The stator has two sets of windings 942 and 944 arranged alongside the armature 902, and a support plate 935 and a base mounting plate 930. As shown in FIG. 9, the armature 902 has moveable portions 911, 912, 913 and 914 arranged in one plane 9P perpendicular to an axis of rotation 9X, and a further set of moveable portions 915, 916, 917 and 918 arranged in another plane 9Q perpendicular to the axis of rotation 9X. The armature 902 has a shaft 905 which is arranged to rotate in bearings 933 and 934.

Support plate 935 may be used to provide an insulating or an earthed barrier between the two sets of windings 942 and 944 and their respective armature portions 946 and 948 respectively.

A benefit of the support plate 935 being non-conductive is that losses arising from eddy currents may be eliminated.

In a further embodiment, the support plate 935 is of a non-magnetic material.

In an alternative embodiment, not shown herein, support plate 935 may carry additional windings, so that the windings are disposed symmetrically about the armature portions 946 and 948.

An electrical connection 940 is provided to connect the windings, in the case of a generator to an electrical load, and in the case of a motor, to an electrical supply.

The moveable portions are arranged so that side faces 968 and 969 are closely adjacent to their respective coil faces 945 and 943. Hence a magnetic coupling between the armature and the stator when the moveable portions are in the second position can be optimised. Each moveable portion has a curved face 970 having a recess similar to the first embodiment for receiving an end 980 of a bar 971 on which the moveable portion may move away from the axis of rotation as the speed of rotation of the armature increases. As in the first embodiment the bars are mounted rigidly to a hub 975, and resilient members 907 are provided to urge the moveable portions towards the axis 9X.

FIG. 10 is an end view along the axis 9X of the second embodiment 900, where for clarity support plate 935 has been omitted from this view. As in FIG. 9 the moveable portions 911, 912, 913 and 914 are in a second position where they are closely positioned adjacent to the stator windings 944. The moveable portions can be seen to be similar to those shown in FIG. 8B, and each have permanent magnets 951 to 958 mounted to them, such that the magnetic field is directed to the side facing the stator coils.

From FIG. 10 it can be seen that a maximum diameter 10 E of the armature across the moveable portions when they are in the second position, is less than a maximum diameter 10F of the stator winding 944.

FIG. 11 is a perspective view of the stator winding 944 and a stator support plate 904 which is arranged to support the winding. The winding 944 may comprise an even or an odd number of coils 946 depending on the requirements for the electrical machine. The coils can be seen to have a substantially flat face 945 arranged to face the moveable portions 911, 912, 913 and 914.

A centre portion 906 of the support plate 904 is of such a material or construction that there is a negligible magnetic coupling between the centre portion and the moveable portions when in the first position.

FIGS. 12, 13 14 and 15 are an end view of the armature 902 as shown in FIG. 10, but with the moveable portions in different positions. It can be seen from these Figures that this embodiment has a symmetrical arrangement of the moveable portions and the bars supporting them. An angular spacing between each is substantially identical. Each moveable portion in an opposed pair of moveable portions is of substantially identical mass, for example 911 is the same mass as 913, and 916 is the same mass as 918. An advantage of this is that the armature may be easily maintained in balance. It should be noted that moveable portion 911 is heavier than moveable portion 915.

However, in an alternative embodiment, not shown, the angular spacing between at least some of the bars is different. In this embodiment balance of the armature may be obtained by careful selection of the masses of the moveable portions.

In FIG. 12 the armature is stationary or only rotating slowly and hence all the moveable portions are in a first position, where the resilient members 907 have drawn the moveable portions up against the hub 975. Hence an overall diameter 12D across the moveable portions is at a minimum.

In FIG. 13 the armature has begun to rotate to a sufficient speed 13R where the lighter set of moveable portions 915, 916, 917 and 918 have moved to an intermediate position. The heavier set of moveable portions 911, 912, 913 and 914 are still in the first position since the resilient members 907 holding them close to the axis 9X exert a proportionately greater force than the resilient members 908 acting on the moveable portions 915 to 918. As the speed continues to increase, in the case of an electrical generator, the winding 942 will commence production of electrical power.

In FIG. 14 the speed 14R of rotation has increased to or beyond the speed at which the first or lighter set of moveable portions are in the second position and the second set of moveable portions have moved to an intermediate position. Hence, as the speed increases further, in the case of an electrical generator, the winding 944 will commence generation of electrical power.

FIG. 15 illustrates the condition where the speed 15R of rotation of the armature has increased sufficiently that all the moveable portions have moved to their second position. Hence in the case of an electrical generator, the output is at a maximum for the particular speed of the armature.

From FIG. 18, a perspective view of apparatus 200 for converting kinetic energy into usable power according to the present invention, shown fixed in a vehicle running track 202, but with a cover removed to show hidden features. The apparatus 200 has a frame 204 arranged to be fixed in the vehicle running track 202 and a plurality of plates 211 to 219 inclusive and 221 to 229 inclusive. Each of the plates is moveably mounted to the frame, so that a vehicle running face 220, 230 (only two labelled) of each plate is substantially level with the surrounding track 202. Each plate is arranged to drive an energy conversion means 232 or 234. The energy conversion means has a rotating member 293 (see FIG. 19) having variable inertia as described with reference to FIGS. 1 to 17 above. Since the frame is fixed in the track, each plate 211 to 219 inclusive and 221 to 229 inclusive is movable in relation to the frame 204 and in relation to the track 202. The plates 211 to 219 inclusive and 221 to 229 inclusive are arranged as two sets of plates 501 and 502 respectively. Each of the plates is pivotally mounted to the frame 204, at a pivoted end 505 and 507. In the embodiment shown in FIG. 1 the pivoted ends are adjacent the longitudinal centre line 200C. Each plate is pivotally mounted about a pivot axis 515 and 517, which are symmetrically disposed about axis 200C, by distance 516.

An intention of the invention is that the energy conversion means 232 and or 234 is enabled to provide useable power derived from the kinetic energy of passing vehicular traffic. Vehicles approach the apparatus along a direction of arrow 200A. In the special case of two wheeled vehicles, a level uninterrupted path 236 is provided along a centre of the apparatus. For normal four wheeled vehicles, or indeed those with more axles, the wheels will be disposed about either side of a longitudinal centre line 200C along a centre of the apparatus. The wheel tracks will normally be expected to fall within off-side track 240 and near-side track 242. A kerb 244 is provided alongside the apparatus to encourage vehicles to traverse the apparatus as intended. Although not shown, it may be preferred to have a kerb on each side of the apparatus.

While in the embodiment shown the plates have a common pivotal axis, in a particular embodiment it may be convenient for them to have different pivotal axes, in effect providing different effective plate lengths. In another embodiment (not shown) the end pivotally supported end is adjacent a side edge 511, 512 along the vehicle running track.

As a vehicle approaches the apparatus, the front wheels of the vehicle will first contact the first plates 211 and 221 on each side of the apparatus, and then after the front wheels pass over these plates the wheels will then run onto the second plates 212 and 222. Hence the first and second plates are moved sequentially in that order by a vehicle passing over the plates.

From FIG. 19, it can be seen that the movement of each plate 211 to 219 inclusive is arranged to cause rotation of a drive mechanism 250. In operation, as the vehicle drives across the apparatus, the plates 211 to 219 are acted on by the vehicle wheels is sequence. A diameter of the pinions decreases from those on plate 211 to those on plate 219, and hence as the vehicle reaches the end of the ramp and the speed of rotation of the shaft 252 increases, for the same vertical movement 289 of the plate 219 as the movement 281 of plate 211, the racks 279 and 279′ will rotate the pinions 269 and 269′ by a greater angular movement, which given the speed of the vehicle will have remained substantially the same, effectively results in a greater speed of rotation of the shaft 252 than was the case for the substantially identical movement 281 of plate 211.

A gearbox 290 is provided to couple the shaft 252 to an electrical generator 292. The electrical generator 292 is an energy conversion means 232.

Coil springs 291 are provided under each plate to resiliently return the plates to the first positions. All the plates are shown in the first positions in this figure, since the car tyres are at the instant shown, traversing transverse portions of the cover plate between two consecutive plates.

The electrical generator 292 preferably is provided with an armature that changes in effective diameter according to the speed of rotation, as described herein with reference to FIGS. 1 to 17. Hence when starting the generator to rotate, there is a minimum inertia and magnetic resistance to be overcome, reducing stress on the drive mechanism. From FIG. 1, a battery 294 and 294′ can be seen to be connected to the generator output in this particular embodiment.

From FIG. 21 a pair of vehicle wheels 402 and 404 of vehicle 400 can be seen acting on a pair of plates 215 and 225 (not visible in this view) of the apparatus shown in FIG. 1. The vehicle 400 is travelling in the direction of arrow 400A. The previously traversed plate 214 can be seen to have already been resiliently returned to its first position 414 where the plate protrudes the surrounding surface 420 of the cover plate 421 which effectively forms a part of the vehicle track 202. Plate 214 protrudes the surrounding surface 420 by a small distance 416. Meanwhile plate 215 which is being acted on by the tyre tread 407 of tyre 406 has been moved to the second position 415 where it is a small distance 417 below the surrounding surface.

In a practical embodiment, the distances 416 and 417 depend on the type of vehicular traffic likely to pass over the apparatus and its speed. Typically in a low speed location 416 could be, for example 50 mm, but in a high speed location would be less, for example 25 mm. The distance 417 would typically be less than the distance 416. In a particular example distance 416 would conveniently be 25 mm, but could be more where vehicles with larger wheels were traversing the apparatus. In a low speed location, where only heavier vehicles with larger wheels would pass over the apparatus a larger height 416 would be possible, for example 75 mm, or greater.

Plate 215 can be seen to have a smoothly shaped leading edge 422 and trailing edge 423. The plates also have a smoothly shaped end, for example as 218E in FIG. 19.

As the vehicle tyre traverses the plates they are displaced at the end away from the pivotal support by a vertical displacement 424. Mounted to the end of the plate 215 are two rack gears 275 and 275′, which act on pinions 265 and 265′ respectively to rotate the shaft 252. The shaft 252 is supported by the frame 204 by bearings 253.

The movement of the rack gears is substantially linear, although in applications where the plates are relatively short and have a large vertical displacement 424, they may be made slightly curved to conform to the radius of curvature equal to the distance from the pivotal axis of the plate.

Each of the pinions 265 and 265′ is provided with a clutch mechanism 435 and 435′ to enable the shaft to be rotated by other pinions without the pinions 256 and 256′ moving the plate 215.

In FIG. 20, an alternative arrangement for the apparatus 300 is shown with a drive mechanism 302 which has a connecting rod 304 coupled between a plate 311 and a crank-shaft 306 mechanism to translate the substantially vertical movement 300V of the plate to a rotary movement 300R to operate the generator (not shown in this figure). To obtain the maximum displacement of the connecting rod, it is mounted to each of the plates at a distance 300D from the pivotally supported end 308. An alternative embodiment of a connecting rod 304′ is shown in FIG. 20A, having a co-axial slidable piston and cylinder arrangement, to enable the maximum torque applied to the crank to be controlled should the plate be subjected to a sudden downward deflection. The connecting rod 304′ has an internal resilient member to return the rod to its normal operating length. To obtain different mechanical advantage so as to maximise the torque available as a vehicle traverses the first few plates, a length 307 of the crank 306 of the first plate 311 is longer than a length of a crank of a second plate (not shown in this figure). Likewise, the length of the second crank is preferably greater than that of the third, and so on. The shortest crank would be the last crank operated by the last plate traversed by a vehicle as it exits or leaves the apparatus. If an installed apparatus is to be traversed from both directions, then it would be preferable to size the cranks so that the shortest cranks are in a middle section of the apparatus, and the longest cranks are at each end, with the intermediate cranks at intermediate lengths.

A longer crank will impart more torque to the drive mechanism for the same downward force than a shorter crank. However, the shorter crank will impart greater rotational movement to the shaft 310 for the same vertical movement 312.

It should be noted that a similar result may be obtained by positioning the connecting rod and crank arrangement 302 at different distances 300D from the pivot axis 314 of the plate 311 on the different plates. To permit the shaft 310 to rotate without rotating the crank 306, a clutch 313 is provided. Hence as a particular plate is moved in vertically and energy is imparted to the drive mechanism, the other plates in the same set of plates may remain in the first position. This reduces the inertia of the system.

The plate 311 is restrained from moving higher than the first position 321 by a stop 320. The plate 311 is resiliently returned from the second position 322 to the first position 321 by spring 323. A support 324 is provided to protect against excessive loads applied to the vehicle running surface 325 of the plate 311.

The vertical movement of the plate in the direction of 300V is limited, so that a desired angular movement of the crank 306 is obtained. Although a rack and pinion arrangement or a crank and connecting rod arrangement have been shown and described, an alternative embodiment which is not shown, uses hydraulic cylinders operated on by the plates and hydraulic oil as the transmission means to power a hydraulic motor to drive the generator.

In this embodiment it may be preferred to use different diameter cylinders on the different plates, such that the first plate has the smallest cylinder and on a single direction apparatus, the last plate traversed has the largest cylinder.

In another alternative embodiment, pneumatic cylinders and a gaseous transmission media are used.

It will be appreciated that for a particular installation it may be advantageous to combine aspects of these embodiments.

From FIG. 22 a longitudinal cross section of an alternative embodiment 350 of a frame 352 which is shown with cross-hatching omitted for clarity. FIG. 23 is a transverse cross section of the alternative frame 352, also with the cross hatching omitted. The frame 352 comprises a plurality of compartments 353, 354, 355 each of which is arranged to receive a plurality of plates, similar to the plates 211 to 219 and 221 to 229 shown and described with reference to FIG. 18.

In a particular example of the embodiment 350, the frame comprises a housing structure 359 having three compartments 353, 354, and 355 each of the compartments is arranged to receive four plates. Hence a four wheeled vehicle traversing along the plate in the direction of arrow 358A will transverse twelve plates on each side, one set with its nearside wheels, the other set with its offside wheels.

A vehicle travels along the running track 362 and then onto plate surfaces 363, 364 and 365 sequentially. Moveable plates are mounted in each of the plates 363, 364 and 365 arranged to drive the energy conversion means, which may be mounted within any one of the compartments or in a separate adjacent compartment. The running track is preferably bounded by a curb 357 or other guideway to ensure vehicles travel over the mechanism.

The mechanism is arranged to receive energy from the passing vehicle and convert it into useable power using the energy conversion means described herein. Apertures or communication holes are provided to permit power from each of the compartments to be fed through into the adjacent compartments. The transmission means may be by a rotating shaft in respect of mechanical power, and electrically conductive cables for electrical power.

Alternative mechanical transmission means such as axially oscillating transmission shafts could be used.

While a frame comprising three compartments is mentioned above, in a particular application, it may be preferable to have only two compartments, or alternatively to have more compartments.

The housing structure 359 may comprise a preformed component, or it may be preferable for a particular installation site to construct it in situ using materials such as concrete or blockwork. The load of the passing vehicles is transmitted by the housing structure into the supporting ground 360.

In a further embodiment not shown herein, the frame comprises a plurality of housing structures, each with a compartment each arranged for mounting in a vehicle running track, means being provided between each of the housing structures for the transmission of power between each compartment, so that a power output is obtained from the combined energy received by each of the compartments when a vehicle passes over each compartment in sequence.

1. Apparatus for converting kinetic energy into usable power, comprising:
a frame arranged to be fixed in a vehicle running track;
a plurality of plates mounted to the frame;
wherein each plate is movable in relation to the frame so as to drive an energy conversion means; and
wherein the energy conversion means comprises a rotating member having variable inertia.

2. Apparatus as claimed in claim 1, wherein the apparatus further comprises at least a first and a second plate being arranged to be moved sequentially in that order by a vehicle passing over the plates, such movement of each plate arranged to cause rotation of a drive mechanism, wherein at least the second plate is arranged to impart a greater degree of rotation to the drive mechanism than the first plate.

3. Apparatus for converting kinetic energy into usable power, comprising:
a frame arranged to be fixed in a vehicle running track;
a plurality of plates mounted to the frame;
wherein each plate is movable in relation to the frame;
at least a first and a second plate being arranged to be moved sequentially in that order by a vehicle passing over the plates, such movement of each plate arranged to cause rotation of a drive mechanism; and
wherein at least the second plate is arranged to impart a greater degree of rotation to the drive mechanism than the first plate.

4. Apparatus as claimed in claim 3 wherein the apparatus further comprises energy conversion means having a rotating member having variable inertia, the drive mechanism arranged to drive the energy conversion means.

5. Apparatus as claimed in claim 1, wherein the energy conversion means further comprises an electrical generator.

6. Apparatus as claimed in claim 5, wherein the energy conversion means further comprises means for storing electrical energy.

7. Apparatus as claimed in claim 5, wherein the electrical generator further comprises the rotating part having variable inertia.

8. Apparatus as claimed in claim 1, wherein each plate is arranged to protrude the surrounding surface in a first position when it is not acted on by a vehicle.

9. Apparatus as claimed in claim 1, wherein when the plate is in a first position, at least an edge of the vehicle running face is substantially at the same level as the surrounding surface.

10. Apparatus as claimed in claim 8, wherein each plate is arranged to move to a second position when it is acted on by a vehicle.

11. Apparatus as claimed in claim 10, wherein when in the second position a highest portion of the vehicle running face is substantially level with the surrounding surface at at least the portion where a vehicle is acting on the plate.

12. Apparatus as claimed in claim 10, wherein when in the second position a highest portion of the vehicle running face is below a level of the surrounding surface at least a portion of the plate.

13. Apparatus as claimed in claim 1, wherein at least a portion of each of the plates moves in a downwardly substantially vertical direction as a vehicle passes over the plate.

14. Apparatus as claimed in claim 10, wherein each of the plates is resiliently urged from the second position to the first position.

15. Apparatus as claimed in claim 8, wherein each of the plates is restrained from moving higher than the first position.

16. Apparatus as claimed in claim 13, wherein the downwardly substantially vertical direction is an arcuate movement about an axis.

17. Apparatus as claimed in claim 1, wherein each of the plates is pivotally supported at or adjacent to one end so as to resist vertical movement as a vehicle passes over the plate.

18. Apparatus as claimed in claim 1, wherein the plate is arranged to resist horizontal movement.

19. Apparatus as claimed in claim 17, wherein the apparatus further comprises two similar sets of plates, one on either side of a longitudinal centre line along the vehicle running track.

20. Apparatus as claimed in claim 19, wherein the end pivotally supported is adjacent the centre line along the vehicle running track.

21. Apparatus as claimed in claim 19, wherein each plate is arranged to move about a common axial centre line, the axial centre line parallel to the longitudinal centre line of the vehicle running track.

22. Apparatus as claimed in claim 17, wherein the end pivotally supported is adjacent a side edge along the vehicle running track.

23. Apparatus as claimed in claim 19, wherein each plate is arranged to pivotally move about a common axial centre line, the axial centre line parallel to the longitudinal centre line of the vehicle running track.

24. Apparatus as claimed in claim 1, wherein a transverse fixed portion of track is provided between each plate along a line of the vehicle running track.

25. Apparatus as claimed in claim 1, wherein a longitudinal fixed portion of track is provided between each set of plates along the longitudinal centre line.

26. Apparatus as claimed in claim 19, wherein the plates of each of the two similar sets of plates are disposed symmetrically about the longitudinal centre line.

27. Apparatus as claimed in claim 23, wherein the common axial centre line of each set of plates is displaced symmetrically about the longitudinal centre line.

28. Apparatus as claimed in claim 23, wherein the common axial centre line of each set of plates is common between each set of plates, and is coincident with the longitudinal centre line.

29. Apparatus as claimed in claim 5, wherein the energy conversion means further comprises a drive mechanism, the drive mechanism arranged to transmit kinetic energy to the electrical generator.

30. Apparatus as claimed in claim 29, wherein the drive mechanism comprises a geared mechanism to translate the substantially vertical movement of the plates to a rotary movement to operate the generator.

31. Apparatus as claimed in claim 29, wherein the geared mechanism comprises at least a rack and pinion arrangement, a rack being mounted to each of the plates at a distance from the pivotally supported end, each of the rack and pinion arrangements being arranged to translate the substantially vertical movement of the plates to a rotary movement to operate the generator.

32. Apparatus as claimed in claim 31, wherein a diameter of a pinion of a first plate is a larger diameter than a pinion of a second plate.

33. Apparatus as claimed in claim 29, wherein the drive mechanism comprises a connecting rod and crank-shaft mechanism to translate the substantially vertical movement of the plates to a rotary movement to operate the generator.

34. Apparatus as claimed in claim 33, wherein the connecting rod and crank-shaft mechanism comprises a connecting rods mounted to each of the plates at a distance from the pivotally supported end.

35. Apparatus as claimed in claim 33, wherein a length of a crank of a first plate is longer than a length of a crank of a second plate.

36. Apparatus as claimed in claim 33, wherein the plates and drive mechanism further comprises at least a clutch, the clutch or clutches being arranged so that as a particular plate is moved in the substantially vertical direction and energy is imparted to the drive mechanism, the other plates in the same set of plates may remain in the first position.

37. Apparatus as claimed in claim 31, wherein each of the pinions and or cranks comprises a clutch.

38. An electrical rotating machine, comprising a rotatable armature and a fixed stator, the armature arranged to rotate about an axis, wherein the armature comprises a plurality of sets each of a plurality of movable portions, each movable portion movable from at least a first position when the armature is stationary to a second position when the armature is rotating, wherein a dimension of a radial gap between each movable portion and the stator decreases when the moveable portion moves from the first position to the second position, the armature and the stator are arranged such that a magnetic flux coupling the armature and the stator crosses the gap when the movable portions are in the second position, and wherein at least a first set is arranged to move to the second position at a first speed of rotation, and at least a second set is arranged to move to the second position at a second speed of rotation, the second speed being higher than the first speed.

39. An electrical rotating machine as claimed in claim 38, wherein the rotating machine is an electrical generator.

40. An electrical rotating machine as claimed in claim 38, wherein the electrical machine is an electric motor.

41. An electrical rotating machine as claimed in claim 38, wherein the moveable portions each comprise at least in part a magnetic portion.

42. An electrical rotating machine as claimed in claim 41, wherein the magnetic portion comprises a permanent magnet.

43. An electrical rotating machine as claimed in claim 41, wherein the magnetic portion comprises an electro-magnet.

44. An electrical rotating machine as claimed in claim 41, wherein the magnetic portion comprises a permanent magnet and an electro-magnet.

45. An electrical rotating machine as claimed in claim 38, wherein the moveable portions are resiliently urged towards the axis of rotation.

46. An electrical rotating machine as claimed in claim 38, wherein moveable portions are arranged to move to the second position at a particular angular speed.

47. An electrical rotating machine as claimed in claim 38, wherein the magnetic flux coupling between the armature and the stator when the moveable portions are in the first position is less than half the magnetic flux coupling in the second position.

48. An electrical rotating machine as claimed in claim 38, wherein the moveable portions are arranged to move radially.

49. An electrical rotating machine as claimed in claim 38, wherein the moveable portions move arcuately.

50. An electrical rotating machine as claimed in claim 38, wherein the armature is arranged to rotate within the stator.

51. An electrical rotating machine as claimed in claim 38, wherein a moment of inertia of the armature when the moveable portions are in the first position is less than the moment of inertia when the moveable portions are in the second position.

52. (canceled)

53. Apparatus for converting kinetic energy into usable power, comprising:
a frame arranged to be fixed in a vehicle running track;
a plurality of plates mounted to the frame;
wherein each plate is movable in relation to the frame so as to drive an energy conversion means;
wherein the energy conversion means comprises a rotating member having variable inertia;
wherein the apparatus further comprises an electrical generator comprising an electrical rotating machine; and
the electrical rotating machine comprising a rotatable armature and a fixed stator, the armature arranged to rotate about an axis, wherein the armature comprises a plurality of sets each of a plurality of movable portions, each movable portion movable from at least a first position when the armature is stationary to a second position when the armature is rotating, wherein a dimension of a radial gap between each movable portion and the stator decreases when the moveable portion moves from the first position to the second position, the armature and the stator are arranged such that a magnetic flux coupling the armature and the stator crosses the gap when the movable portions are in the second position, and wherein at least a first set is arranged to move to the second position at a first speed of rotation, and at least a second set is arranged to move to the second position at a second speed of rotation, the second speed being higher than the first speed.

54. Apparatus for converting kinetic energy into usable power, comprising:
a frame arranged to be fixed in a vehicle running track;
a plurality of plates mounted to the frame;
wherein each plate is movable in relation to the frame;
at least a first and a second plate being arranged to be moved sequentially in that order by a vehicle passing over the plates, such movement of each plate arranged to cause rotation of a drive mechanism;
wherein at least the second plate is arranged to impart a greater degree of rotation to the drive mechanism than the first plate;
wherein the apparatus further comprises an electrical generator comprising an electrical rotating machine;
the electrical rotating machine comprising a rotatable armature and a fixed stator, the armature arranged to rotate about an axis, wherein the armature comprises a plurality of sets each of a plurality of movable portions, each movable portion movable from at least a first position when the armature is stationary to a second position when the armature is rotating, wherein a dimension of a radial gap between each movable portion and the stator decreases when the moveable portion moves from the first position to the second position, the armature and the stator are arranged such that a magnetic flux coupling the armature and the stator crosses the gap when the movable portions are in the second position, and wherein at least a first set is arranged to move to the second position at a first speed of rotation, and at least a second set is arranged to move to the second position at a second speed of rotation, the second speed being higher than the first speed; and
wherein the moveable portions each comprise at least in part a magnetic portion.

55. (canceled)
